(19) United States
(12) Patent Application Publication
(10) Pub. No.: US 2010/0170409 A1
(43) Pub. Date: Jul. 8, 2010

(54) STAMP PEN

(75) Inventor: Yu Keung Chan, Hong Kong (CN)

Correspondence Address: SCHMEISER, OLSEN & WATTS, 22 CENTURY HILL DRIVE, SUITE 302, LATHAM, NY, 12110, US

(73) Assignees: Yu Keung Chan, Hong Kong (CN); Wing Fat Chan, Hong Kong (CN); Yu Kin Chan, Hong Kong (CN)

(21) Appl. No.: 12/602,162

(22) PCT Filed: Jul. 15, 2008
(86) PCT No.: PCT/CN08/71645

§ 371 Date: Nov. 30, 2009

(30) Foreign Application Priority Data
Aug. 21, 2007 (CN) 20720055865.3

(51) Int. Cl. B41K 1/42

(52) U.S. Cl. 101/333

(57) ABSTRACT

The present invention discloses a stamp pen including a housing, an ink-permeable foam pad, a hood and a cover, wherein the ink-permeable foam pad is embedded in the hood, the hood is snapped at the housing, a spring supporting the ink-permeable foam pad is provided between the hood and the housing, an elastic leak-proof member is provided on the ink-outlet of the housing, and the ink-permeable foam pad is attached on the outlet of the leak-proof member. Compared to with the prior art, the stamp pen according to the present invention is improved by adding an elastic leak-proof member, which can close and seal the housing to prevent the ink from leaking from the housing when the stamp pen is in unused state. When the stamp pen is in use, the ink is discharged appropriately to stamp a pattern on a paper properly. Besides, the ink-permeable foam pad has a great ink-stored ability and appropriate rigidity, therefore users can effectively control the ink flow of the stamp pen in every dab, and produce an aesthetic pattern neatly.

### FIELD OF THE INVENTION

The present invention relates to a stamper and the technical field of the stamper, more particularly, to a stamp pen with improved structure.

### BACKGROUND OF THE INVENTION

For the conventional stamper, the stamper and the accompanying stamp-pad ink are usually stored separately, and the stamper must be stained with the ink when in use. This kind of stamper would cause the stamp having different color depth, also make the user's hands dirty easily, and is inconvenient to store and carry, further it could not be used without the stamp-pad ink, which limits its use. There is another kind of stamper called “Pre-inked Chop”, which could be used for stamping without any extra stamp-pad ink, but the stamping times of this stamper is limited, the lifetime is short and uninterrupted operation and reiterative use is unavailable, which increases the total cost and is bad for the environment. There is also another kind of stamper called “Bingo Marker”, which is used in the Bingo games and comprises a circular stamp pad formed from sponge, however, the stamp pattern and the ink discharge is difficult to control well, which results in different pattern sizes and waste respectively.

Referring to FIG. 1, a stamp pen is disclosed in the Chinese Utility Model patent No. CN98234567.4 by this applicant. This stamp pen can be used without any extra stamp-pad ink, and can be used uninterruptedly and reiteratively with a long lifetime. Although this stamp pen has a simple structure and low cost, and meets the environmental protection requirements, it still has certain disadvantages. It would make things stained and waste the ink easily if uncovering, and the ink-permeable foam pad is putrescible to be damaged, because in this patent, the reservoir joins the ink-permeable foam pad together, such that the ink-permeable foam pad is always in the wetness status. Therefore, it is necessary to improve these defections of this patent.

### SUMMARY OF THE INVENTION

The purpose of the present invention is to overcome said defections and provide a stamp pen that has a simple structure and low cost, meets the environmental protection requirements, and prevents the ink from leaking. The present invention is particularly designed for the Bingo games as a Bingo Marker for number marking in the game paper.

To achieve this purpose, the present invention is implemented by the technical solution as following:

a stamp pen that comprises a housing, an ink-permeable foam pad, a hood and a cover, wherein said ink-permeable foam pad is embedded in said hood, said hood is snapped at said housing, a spring supporting said ink-permeable foam pad is provided between said hood and said housing, an elastic leak-proof member is provided on the ink-outlet of said housing, and said ink-permeable foam pad is attached on the outlet of said elastic leak-proof member. The elastic leak-proof member can close and seal the ink-outlet of the housing, so as to prevent the ink from leaking from the housing when the stamp pen is in unused state. Although the stamp pen sometimes is not covered by the cover, the ink will not be wasted and things will not be stained, in the meantime, the ink-permeable foam pad can be kept in dry when it is in unused state, which to results in longer lifetime.

The foresaid elastic leak-proof member comprises an enclosure having two opening ends; a block member osculating with an opening end of said enclosure hermetically; and a plastic spring extending along the inner wall of said enclosure, one end of which is attached to the inner wall of said enclosure and the other end of which is attached to said block member. While the stamp pen is in use, the plastic spring is compressed to be shrunk, and the block member will be detached from the enclosure, the ink is thus exuded from the housing to the ink-permeable foam pad. While the stamp pen is in unused state, the plastic spring resumes its normal status under its self-elasticity, and makes the block member osculating with the enclosure hermetically, so that the ink is prevented from leaking, and the waste is avoided.

A metal ring is configured on the outer of said ink-permeable foam pad. The ink-permeable foam pad is movable within the hood, and has a great ink-stored ability and appropriate rigidity, so that the user can easily control the ink flow and perform the stamping. The metal ring is to strengthen the rigidity of the ink-permeable foam pad. As the ink-permeable foam pad is attached to and compressed by the spring, its distortion may occur without the strength of the metal ring, and even it may be extruded out of the hood, affecting the normal use.

Further, said metal ring is a stainless steel ring.

Compared with the prior art, the structure of the stamp pen according to the present invention is improved by adding an elastic leak-proof member. When the stamp pen is in unused state, the elastic leak-proof member can close and seal the ink-outlet of the housing, so as to prevent the ink from leaking from the housing and keep the ink-permeable foam pad in dry, such that things will not be stained, the ink will not be wasted, and it is also good for the environment.

The present invention will be described further referring to the accompanying drawings and the embodiments.

### BRIEF DESCRIPTION OF THE DRAWINGS

FIG. 1 depicts a sectional view of the stamp pen in the prior art;

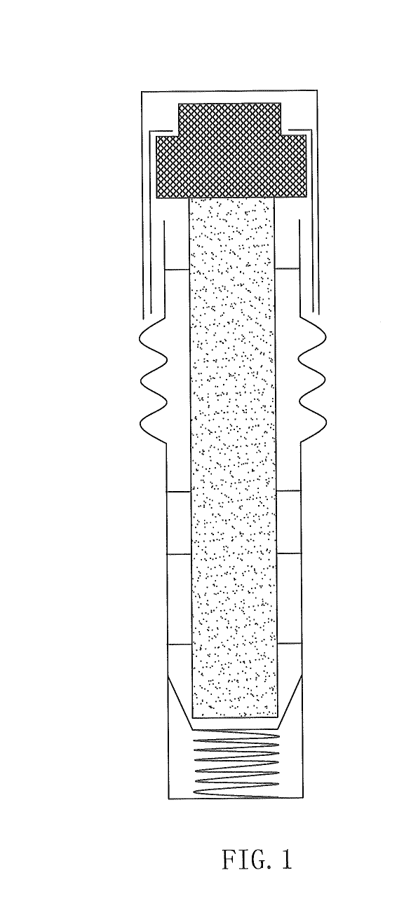

FIG. 2 depicts an exploded view of the stamp pen of the present invention;

FIG. 3 depicts a sectional view of the stamp pen of the present invention;

FIGS. 4a and 4b depict a working status view of the elastic leak-proof member of the present invention respectively.

### DETAILED DESCRIPTION OF THE PREFERRED EMBODIMENTS

### Embodiment

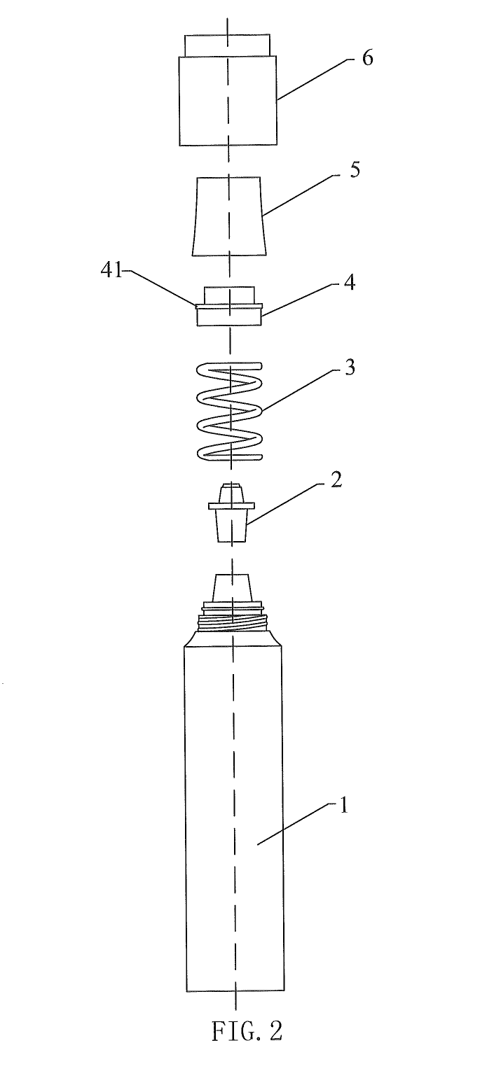

Referring to FIG. 2, the stamp pen of the present invention comprises a housing 1, an ink-permeable foam pad 4 engraved with a pattern, a hood 5 for fixing the ink-permeable foam pad and a cover 6, wherein said ink-permeable foam pad 4 is movably embedded in said hood 5, and said hood 5 is snapped at said housing 1.

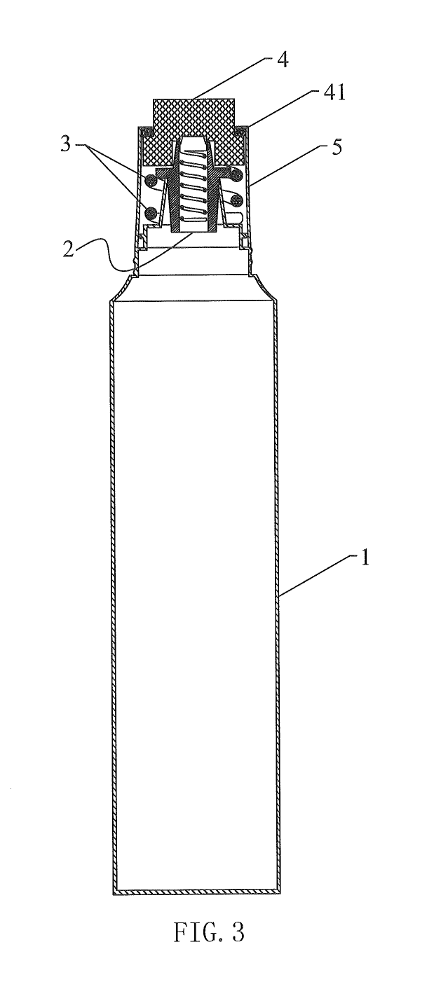

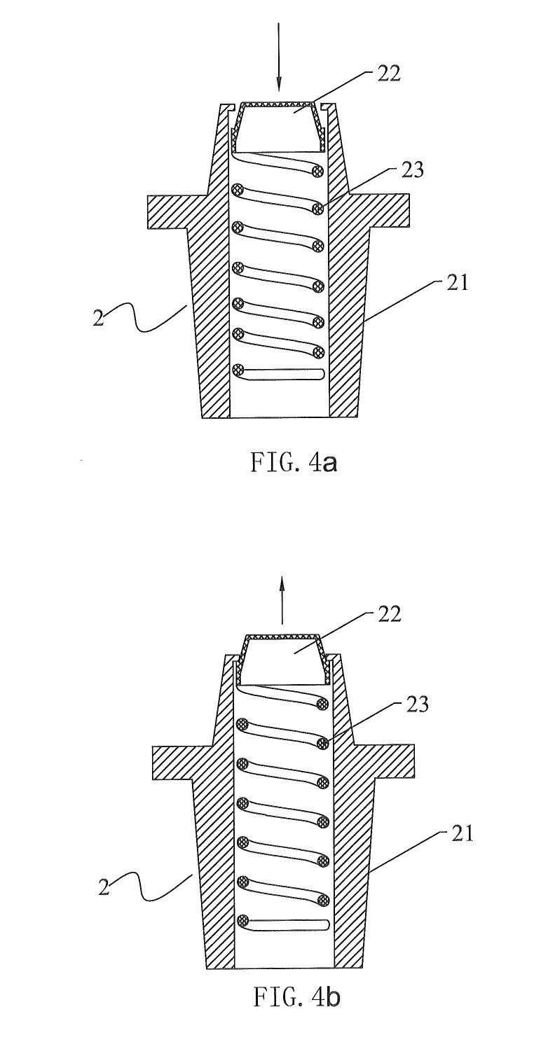

Referring to FIG. 3 and FIG. 4, an elastic leak-proof member 2 is provided on the ink-outlet of said housing 1. The elastic leak-proof member 2 comprises an enclosure 21 having two opening ends, the narrow opening end of which is the outlet that is attached to said ink-permeable foam pad 4; a block member 22 formed by the molded plastic and osculating with the outlet of said enclosure 21 hermetically; a plastic spring 23 extending along the inner wall of said enclosure 21, one end of which is attached to the inner wall of said enclosure 21 and the other end of which is attached to said block member 22. Referring to FIG. 4a, while the plastic spring 23 is compressed to be shrunk, the block member 22 will be detached from the enclosure 21, the ink is thus exuded from the housing to the ink-permeable foam pad. Referring to FIG. 4b, while the plastic spring 23 resumes its normal status under its self-elasticity, it will press the block member 22 to osculate with said enclosure 21 hermetically, so that the ink is prevented from leaking.

Referring to FIG. 2 and FIG. 3, a spring 3 is provided between the hood 5 and the housing 2, one end of which is attached to the ink-permeable foam pad 4, and the other end of which is attached to the housing 1. The spring 3 provides a support for the ink-permeable foam pad 4. When the spring 3 is in non-compressed status, the spring 3 extends to push the ink-permeable foam pad 4 out of the hood 5; when the spring 3 is in compressed status, the spring is shrunk under the pressure, the ink-permeable foam pad 4 returns back to be parallel with the edge of the hood 5, and compresses the block member 22 of the elastic leak-proof member. A stainless steel ring 41 is configured on the outer of said ink-permeable foam pad 4. The function of the stainless steel ring 41 is to strengthen the rigidity of the ink-permeable foam pad 4. As the ink-permeable foam pad 4 is attached to and compressed by the spring 3, the ink-permeable foam pad 4 may be distorted and extruded out of the hood 5 without the strengthening effect of the stainless steel ring 41.

When the stamp is required, put the ink-outlet of the housing downward and aim the ink-permeable foam pad at the position to be stamped, then press the ink-permeable foam pad downward, driving the spring to be shrunk, so that the block member will be compressed upward, driving the plastic spring thereof to be shrunk, and will be detached from the enclosure, the ink is thus exuded from the housing to the ink-permeable foam pad, and the stamp will be made to eventually at the required position. Thereafter, the pressure on the ink-permeable foam pad will be withdrawn, and the ink-permeable foam pad resumes its normal status under the restoring force of the spring and protrudes from the hood, driving the plastic spring to extend and driving the block member to osculate with the enclosure hermetically, so that the ink is prevented from leaking from the housing.

A pattern, such as engraved veins or flowers, or plain dot, is provided on the top of the ink-permeable foam pad 4, having a diameter of 15 mm. When the stamp pen is operated, the pattern is aimed at the position to be stamped, and then the ink-permeable foam pad is pressed downward. The compressed ink-permeable foam pad 4 will absorb the ink from the housing and transfer it to the pattern on the top thereof, so the stamp pen will stamp an integrated, clear and large pattern on the required position in a short time. Said pattern may be in a flower shape, heart shape etc, in order to produce an aesthetic pattern.

For the Bingo games, the user can choose the stamp pens with various colors and patterns according to their favorite, which will spice up the Bingo games.

It is to be understood that the present invention includes but is not limited to the disclosed embodiments. The scopes of the appended claims encompass all the modifications and the equivalents which are apparent to those skilled in the art. Any non-substantive, obvious alterations or improvement by the technician of this technical field according to the present invention may be incorporated into the ambit of claims of the present invention.

What is claimed is:

1. A stamp pen comprising a housing 1, an ink-permeable foam pad 4, an hood 5 and a cover 6, said ink-permeable foam pad 4 being embedded in said hood 5 and said hood 5 being snapped at said housing 1, wherein a spring 3 supporting said ink-permeable foam pad is provided between said hood 5 and said housing 1, an elastic leak-proof member 2 is provided on the ink-outlet of said housing 1, and said ink-permeable foam pad 4 is attached on the outlet of said elastic leak-proof member 2.

2. The stamp pen according to claim 1, wherein said elastic leak-proof member 2 comprises:
an enclosure 21 having two opening ends;
a block member 22 osculating with an opening end of said enclosure 21 hermetically; and
a plastic spring 23 extending along the inner wall of said enclosure 21, one end of which is attached to the inner wall of said enclosure 21, and the other end of which is attached to said block member 22.

3. The stamp pen according to claim 1, wherein a metal ring is configured on the outer of said ink-permeable foam pad 4.

4. The stamp pen according to claim 3, wherein said metal ring is a stainless steel ring 41.

5. The stamp pen according to claim 1, wherein a pattern is engraved on the top of said ink-permeable foam pad 4, with a diameter of 15 mm.
